(19) United States
(12) Patent Application Publication
(10) Pub. No.: US 2013/0290787 A1
(43) Pub. Date: Oct. 31, 2013

(54) SYSTEM AND METHOD FOR RECORDING SYSTEM EVENT LOGS OF SERVER

(71) Applicants: XIAN-KUI CHEN, Shenzhen City (CN); HAI-LI WANG, Shenzhen City (CN)

(72) Inventors: XIAN-KUI CHEN, Shenzhen City (CN); HAI-LI WANG, Shenzhen City (CN)

(73) Assignees: HON HAI PRECISIION INDUSTRY CO., LTD., Tu-Cheng (TW); HONG FU JIN PRECISION INDUSTRY (ShenZhen) CO., LTD., Shenzhen City (CN)

(21) Appl. No.: 13/559,624

(22) Filed: Jul. 27, 2012

(30) Foreign Application Priority Data
Apr. 28, 2012 (CN) 201210132129.9

(51) Int. Cl. G06F 11/34

(52) U.S. Cl. 714/37; 714/E11.189

(57) ABSTRACT

A method for recording managing SELs of a server includes the following steps. Periodically determining a current number of the SELs stored in a storage unit of the server. Comparing the current number with a historical number to determine newly generated SELs. If the current number is greater than the historical number, determining whether the storage unit is full. If the storage unit is full, controlling the BMC to transfer the newly generated SELs to a cache unit. The stored SELs are erased in the storage unit. Transferring the SELs in the cache unit to the storage unit when the SELs in the storage unit are erased. The historical number is updated.

### BACKGROUND

1. Technical Field

The present disclosure relates to information processing systems, and particularly, to a system and a method for recording system event logs (SELs) of a server.

2. Description of Related Art

A baseboard management controller (BMC) in a server provides a function for detecting system status of the server to satisfy the requirements for efficient testing of server stability. Typically, the BMC utilizes sensors to monitor various working conditions of firmware and hardware of the server, such as a fan speed, a microprocessor temperature, and so forth, and further records the monitored abnormal working conditions as a SEL and stores the SEL in a storage unit of the server.

However, because the limited capacity of the storage unit, the server needs to delete the stored SELs when the storage unit is full to allow the new generated SELs to be stored, which causing the recently generated SELs cannot be achieved.

Therefore, what is needed is a means to solve the problem described above.

### BRIEF DESCRIPTION OF THE DRAWINGS

Many aspects of the present disclosure should be better understood with reference to the following drawings. The units in the drawings are not necessarily drawn to scale, the emphasis instead being placed upon clearly illustrating the principles of the present disclosure. Moreover, in the drawings, like reference numerals designate corresponding portions throughout the views.

FIG. 1 is a block diagram of a system for recording System Event Logs of a server, in accordance with an exemplary embodiment.

FIG. 2 is a block diagram of a system for recording System Event Logs of a server, in accordance with another exemplary embodiment.

FIG. 3 is a flowchart of a method for recording System Event Logs of a server, in accordance with an exemplary embodiment.

### DETAILED DESCRIPTION

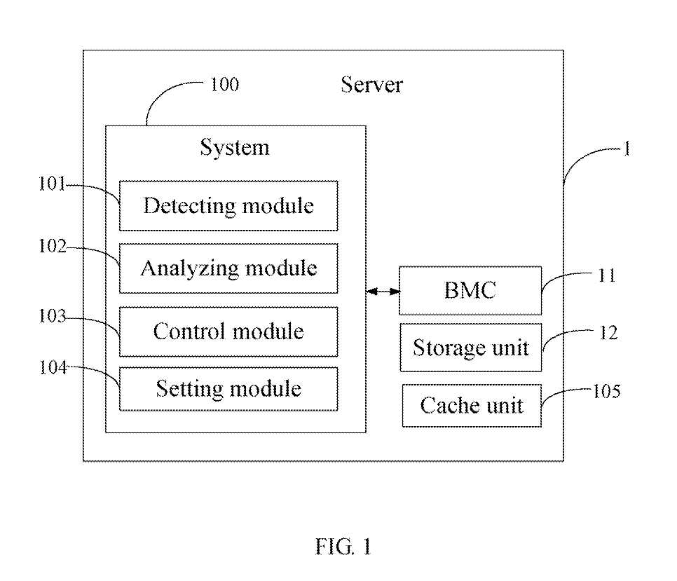

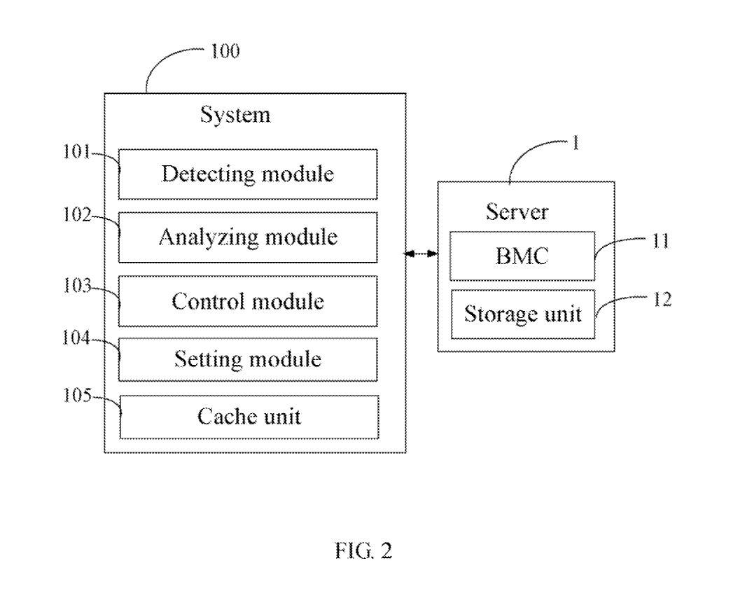

FIGS. 1-2 show a system 100 for recording SELs of a server 1, according to an exemplary embodiment. FIG. 1 illustrates the system 100 is located in the server 1. The server 1 includes a BMC 11 configured to detect whether the server 1 has abnormal conditions, and generate a SEL when such abnormal conditions happen. The server 1 further includes a storage unit 12, such as a Non-Volatile Random Access Memory (NVRAM), which is configured to store the SEL generated by the BMC 11. FIG. 2 illustrates in an alternative embodiment of the system 100. In this embodiment, the system 100 may be an auto-running application applied to a removable storage device, such as a mobile hard disk or a USB disk. The system 100 includes a variety of modules. When the removable storage device is connected to the server 1, the modules are executed to provide the functions of the system 100.

In the embodiment, the system 100 includes a detecting module 101, an analyzing module 102, and a control module 103.

The detecting module 101 periodically determines the current number of the SELs stored in the storage unit 12. In the embodiment, the period for determining the current number is set by a user via an input device such as a keyboard (not shown). In this case, the system 100 further includes a setting module 104 which provides a setting window for users to input the period via the input device. The detecting module 101 responds to the input period and then periodically determines the current number of the SELs.

The analyzing module 102 compares the determined current number with a historical number to determine the newly generated SELs in the storage unit 12, and the historical number is the number of the SELs that has been determined in the previously period, and when the current number is determined in each period, the historical number is updated with the determined current number. If the current number is greater than the historical number, the analyzing module 102 further determines whether the storage unit 12 is full according to the current number of the SELs. Take a NVRAM with a storage capacity equivalent to 512 SELs as an example. If 512 SELs are already stored in the NVRAM, the analyzing module 102 determines that the storage unit 12 is full.

The control module 103 generates a control signal when the storage unit 12 is full to direct the BMC 11 to transfer the newly generated SELs to a cache unit 105, erases all the stored SELs in the storage unit 12, and then transfers the SELs in the cache unit 105 to the storage unit 12 when the SELs in the storage unit 12 are completely erased. Thereby, the newly generated SELs can be retained in the storage unit 12. In the embodiment, the cache unit 105 is another storage unit located in the server 1. In an alternative embodiment, the cache unit 105 may be located in the system 100.

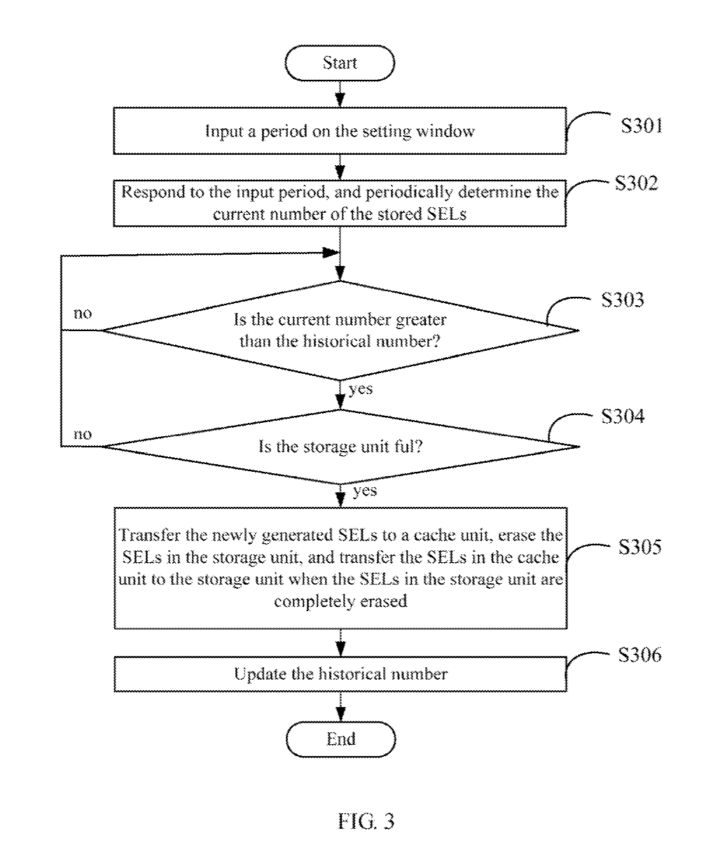

FIG. 3 is a flowchart of a method for recording System Event Logs, in accordance with an exemplary embodiment.

In step S301, through an input device, the users input the period on the setting window provided by the setting module 104.

In step S302, the detecting module 101 responds to the input period, and then periodically determines the current number of the SELs stored in the storage unit 12.

In step S303, the analyzing module 102 compares the determined current number with the historical number to determine whether the newly generated SELs in the storage unit 12, wherein the historical number is a previously determined current number of the SELs. If the current number is greater than the historical number, the procedure goes to step S304; otherwise, the procedure goes back to step S303.

In step S304, the analyzing module 102 determines whether the storage unit 12 is full according to the current number of the SELs. If yes, the procedure goes to step S305; otherwise, the procedure goes back to step S303.

In step S305, the control module 103 generates a control signal to direct the BMC 11 to transfer the newly generated SELs to a cache unit 105, erases all the stored SELs in the storage unit 12, and then transfers the SELs in the cache unit 105 to the storage unit 12 when the SELs in the storage unit 12 are completely erased.

In step S306, the control module 103 updates the historical number with the determined current number.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A system configured for recording system event logs of a server, the server comprising a baseboard management controller to generate the system event logs and a storage unit to store the generated system event logs, the system comprising:
a detecting module to periodically determine a current number of the system event logs stored in the storage unit;
an analyzing module to compare the determined current number with a historical number to determine newly generated system event logs, and further determine whether the storage unit is full according to the current number of the system event logs if the current number is greater than the historical number, wherein the historical number is a number of the system event logs determined in a previously period; and
a control module to generate a control signal when the storage unit is full to direct the baseboard management controller to transfer the newly generated system event logs to a cache unit, erase all the stored system event logs in the storage unit, transfer the system event logs in the cache unit to the storage unit when the system event logs in the storage unit are completely erased, and then update the historical number with the determined current number.

2. The system of claim 1, wherein the system is located in the server and connected to the baseboard management controller.

3. The system of claim 1, wherein the system is an auto-running application applied to a removable storage device, when the removable storage device is connected to the server, the modules of the system are executed.

4. The system of claim 1, further comprising a setting module, wherein the setting module is configured to provide a setting window for users to input a period, and the detecting module is further configure to respond to the input period and periodically determine the current number of the system event logs.

5. The system of claim 1, wherein the cache unit is located in the system.

6. The system of claim 1, wherein the cache unit is located in the server.

7. A method configured for recording system event logs of a server, the server comprising a baseboard management controller to generate the system event logs and a storage unit to store the generated system event logs, the method comprising:
periodically determining a current number of the system event logs stored in the storage unit;
comparing the determined current number with a historical number to determine newly generated system event logs, wherein the historical number is a number of the system event logs determined in a previously period;
determining whether the storage unit is full according to the current number of the system event logs if the current number is greater than the historical number;
generating a control signal when the storage unit is full to direct the baseboard management controller to transfer the newly generated system event logs to a cache unit, erasing the stored system event logs in the storage unit, and transferring the system event logs in the cache unit to the storage unit when the system event logs in the storage unit are completely erased; and
updating the historical number with the determined current number.

8. The method of claim 7, wherein the step periodically determining a current number of the system event logs stored in the storage unit comprises:
providing a setting window for users to input a period; and
responding to the input period and periodically determine a current number of the system event logs stored in the storage unit.
